(19) United States
(12) Patent Application Publication
(10) Pub. No.: US 2026/0109198 A1
(43) Pub. Date: Apr. 23, 2026

(54) THERMAL CONDITIONING SYSTEM

(71) Applicant: VALEO SYSTEMES THERMIQUES, Le Mesnil-Saint-Denis (FR)

(72) Inventor: Mohamed Yahia, Le Mesnil-Saint-Denis (FR)

(73) Assignee: VALEO SYSTEMES THERMIQUES, Le Mesnil-Saint-Denis (FR)

(21) Appl. No.: 19/114,206

(22) PCT Filed: Sep. 15, 2023
(86) PCT No.: PCT/EP2023/075497

§ 371 Date: Mar. 21, 2025

(30) Foreign Application Priority Data
Sep. 21, 2022 (FR) FR2209561

(51) Int. Cl. B60H 1/32; B60H 1/00; B60L 58/24; H01M 10/613; H01M 10/625; H01M 10/6551; H01M 10/6569

(52) U.S. Cl. CPC B60H 1/32281; B60H 1/00278; B60L 58/24; H01M 10/613; H01M 10/625; H01M 10/6551; H01M 10/6569; B60H 2001/00307; H01M 2220/20

(57) ABSTRACT

A thermal conditioning system for a motor vehicle, including a refrigerant circuit. The refrigerant circuit includes a main loop, a first bypass branch, a third bypass branch, and a fourth bypass branch. The main loop includes, successively a compressor, a first heat exchanger configured to exchange heat with a first heat transfer fluid, a first expansion valve, a first refrigerant accumulation device, a second expansion valve, and a second heat exchanger. The first bypass branch includes a third expansion valve, and a third heat exchanger. The second bypass branch connects the main loop and the first bypass branch. The third bypass branch connects the main loop and the first bypass branch. The fourth bypass branch allows the refrigerant leaving the compressor to join the main loop, without passing through the first exchanger and the second expansion valve. The fourth bypass branch includes a fourth expansion valve.

### TECHNICAL FIELD

The present invention relates to the field of thermal conditioning systems. Such systems may, for example, be fitted to motor vehicles. These systems allow thermal regulation of various members, such as the passenger compartment or an electrical energy storage battery, when the vehicle is electrically powered. Exchanges of heat are mainly managed by the compression and expansion of a refrigerant fluid circulating in a circuit in which a plurality of heat exchangers are disposed. A compressor makes it possible to bring the refrigerant fluid to high pressure and to circulate it in the circuit.

### PRIOR ART

The refrigerant fluid circuit usually comprises a main loop and a plurality of bypass branches that make it possible to realize multiple combinations of circulation of the refrigerant fluid. Numerous operating modes can thus be obtained, such as the cooling of the air in the passenger compartment, the heating of the air in the passenger compartment, the dehumidification of the air in the passenger compartment, control of the temperature of the vehicle batteries, or recovery of energy dissipated by these batteries, in order to heat the passenger compartment.

In order to optimize the thermodynamic performance of the thermal conditioning system, it is known to add an additional heating device in order to have a sufficient heating power when the ambient temperature is particularly cold, for example negative. It is also common to install an exchanger that makes it possible to subcool the refrigerant fluid in order notably to improve the available cooling power. However, the addition of these components also has the effect of increasing the complexity of the system, and also its cost and its weight.

There is therefore a need to have thermal conditioning systems exhibiting improved performance without resorting to specific devices such as an additional heating device.

### SUMMARY

To this end, the present invention proposes a thermal conditioning system for a motor vehicle, comprising a refrigerant fluid circuit configured to circulate a refrigerant fluid, the refrigerant fluid circuit comprising:
a main loop comprising, successively in the direction of circulation of the refrigerant fluid:
   a compressor,
   a first heat exchanger configured to exchange heat with a first heat transfer fluid,
   a first expansion device,
   a first refrigerant fluid accumulation device,
   a second expansion device,
   a second heat exchanger,
a first bypass branch connecting a first connection point disposed on the main loop between the first refrigerant fluid accumulation device and the second expansion device to a second connection point disposed on the main loop between the second heat exchanger and an inlet of the compressor, the first bypass branch comprising a third expansion device and a third heat exchanger,
a second bypass branch connecting a third connection point disposed on the main loop between the first expansion device and the first refrigerant fluid accumulation device to a fourth connection point disposed on the first bypass branch between the first connection point and the third expansion device,
a third bypass branch connecting a fifth connection point disposed on the main loop between the first expansion device and the third connection point to a sixth connection point disposed on the first bypass branch between the third heat exchanger and the second connection point,
a fourth bypass branch connecting a seventh connection point disposed on the main loop between an outlet of the compressor and the first heat exchanger to an eighth connection point disposed on the main loop between the second expansion device and the second connection point, the fourth bypass branch comprising a fourth expansion device.

This architecture of the refrigerant fluid circuit makes it possible to obtain numerous operating modes that notably make it possible to heat the first heat transfer fluid at the first exchanger using heat recovered at the second exchanger or the third exchanger. The fourth bypass branch additionally makes it possible to increase the flow rate of refrigerant fluid circulating in the circuit and thus the thermal power provided to the refrigerant fluid. With respect to traditional architectures, this architecture makes it possible to dispense with an additional heating device and with a subcooling exchanger.

The features listed in the paragraphs below may be implemented independently of one another or in any technically possible combination:

According to one aspect of the thermal conditioning system, the first heat exchanger is configured to operate as a condenser.

According to another aspect of the thermal conditioning system, the second heat exchanger is configured to operate as an evaporator.

According again to one aspect of the present disclosure, the third heat exchanger is configured to exchange heat with an air flow outside the passenger compartment of a motor vehicle.

The third heat exchanger is configured to operate selectively as an evaporator or as a condenser.

The first refrigerant fluid accumulation device is a receiver drier.

According to one embodiment, the main loop comprises a second refrigerant fluid accumulation device disposed between the second heat exchanger and the second connection point.

The second refrigerant fluid accumulation device makes it possible to protect the compressor against the presence of refrigerant fluid in liquid form, when the ambient temperature is negative.

The second refrigerant fluid accumulation device is an accumulator.

According to one embodiment of the thermal conditioning system, the eighth connection point is disposed on the main loop between the second expansion device and the second heat exchanger.

According to an embodiment variant of the thermal conditioning system, the eighth connection point is disposed on the main loop between the second heat exchanger and the second accumulation device.

According to one embodiment, the thermal conditioning system comprises a refrigerant fluid distribution module comprising:
a first refrigerant fluid inlet,
a second refrigerant fluid inlet,
a refrigerant fluid outlet,
a first duct connecting the first inlet to the outlet,
a second duct connecting the second inlet to a connecting point disposed on the first duct between the first inlet and the outlet,
the second accumulation device,
the fourth expansion device.

The second accumulation device is disposed on the first duct between the connecting point and the outlet, and the fourth expansion device is disposed on the second duct between the second inlet and the connecting point.

According to one embodiment of the thermal conditioning system, the first heat transfer fluid is an air flow inside a passenger compartment of the vehicle.

According to one embodiment, the thermal conditioning system comprises a fifth bypass branch connecting a ninth connection point disposed on the main loop between the first connection point and the second expansion device to a tenth connection point disposed on the main loop between the second accumulation device and the second connection point. The fifth bypass branch comprises a fifth expansion device and a fourth heat exchanger.

The fourth heat exchanger is configured to operate as an evaporator.

According to one embodiment of the thermal conditioning system, the fourth heat exchanger is configured to exchange heat with an air flow inside the passenger compartment of the vehicle.

In a variant, the fourth heat exchanger is configured to exchange heat with an element of an electric powertrain of the motor vehicle.

According to a variant of the thermal conditioning system, the first heat transfer fluid is a heat transfer liquid.

In this variant, the thermal conditioning system comprises a heat transfer liquid circuit configured to circulate a heat transfer liquid.

In this variant, the first heat exchanger is a two-fluid heat exchanger arranged jointly on the refrigerant fluid circuit and on the heat transfer fluid circuit so as to allow heat exchange between the refrigerant fluid and the heat transfer liquid.

Still in this variant, the heat transfer fluid circuit comprises a fifth heat exchanger configured to exchange heat with an air flow inside the passenger compartment of the vehicle.

According to one aspect of the thermal conditioning system, the second heat exchanger is thermally coupled to an element of an electric powertrain of a motor vehicle.

The element of the electric powertrain of the vehicle may comprise an electrical energy storage battery.

The battery may supply the energy necessary to drive the vehicle.

The element of the electric powertrain of the vehicle may comprise an electric drive motor of the vehicle.

The element of the electric powertrain of the vehicle may comprise an electronic control unit for the electric drive motor of the vehicle.

According to one exemplary embodiment, the second heat exchanger is thermally coupled to the element by way of a heat transfer liquid circulating in a secondary heat transfer liquid loop.

The heat transfer liquid circulating in the secondary heat transfer liquid loop may be a dielectric fluid.

According to another exemplary embodiment, the second heat exchanger is in contact with the element of the powertrain of the vehicle.

According to one aspect of the thermal conditioning system, the first bypass branch comprises a first one-way valve configured to block circulation of refrigerant fluid from the fourth connection point to the first connection point.

According to another aspect of the thermal conditioning system, the second bypass branch comprises a second one-way valve configured to block circulation of refrigerant fluid from the third connection point to the fourth connection point.

The first one-way valve may be a non-return valve. Likewise, the second one-way valve may be a non-return valve.

The main loop comprises a shut-off valve disposed between the sixth connection point and the second connection point.

The fifth bypass branch comprises a third non-return valve configured to block circulation of refrigerant fluid from the tenth connection point to the fourth heat exchanger.

Each non-return valve may be replaced by a shut-off valve.

According to one embodiment, the thermal conditioning system comprises a sixth bypass branch connecting an eleventh connection point disposed on the fourth bypass branch between the fourth expansion device and the eighth connection point to a twelfth connection point disposed on the first bypass branch between the sixth connection point and the second connection point.

According to one embodiment of the thermal conditioning system, the main loop comprises an internal heat exchanger configured to allow heat exchange between the refrigerant fluid downstream of the first connection point and upstream of the second expansion device and the refrigerant fluid downstream of the second accumulation device and upstream of the second connection point.

The internal heat exchanger makes it possible to increase the heat exchange capacity of the system, and also makes it possible to superheat the refrigerant fluid at the inlet of the compressor, i.e. makes it possible to avoid the presence of droplets of liquid refrigerant at the inlet of the compressor.

According to a variant of the thermal conditioning system, the main loop comprises a sixth expansion device disposed on the main loop between the seventh connection point and the first heat exchanger.

This expansion device makes it possible to expand the high-pressure refrigerant fluid exiting the compressor. It is thus possible to operate the compressor at its maximum permissible outlet pressure, and to expand the refrigerant fluid before it is circulated in the first heat exchanger. The compression work is thus increased, making it possible to increase the energy transferred to the refrigerant fluid.

Each expansion device may be an electronic expansion device.

The thermal conditioning system may comprise a first three-way valve disposed jointly on the main loop and on the third bypass branch, the first three-way valve being configured to selectively:
allow circulation of the refrigerant fluid at the outlet of the first exchanger to the third connection point and prevent circulation of the refrigerant fluid at the outlet of the first exchanger to the sixth connection point, or
allow circulation of the refrigerant fluid at the outlet of the first exchanger to the sixth connection point and prevent circulation of the refrigerant fluid at the outlet of the first exchanger to the third connection point.

According to one exemplary embodiment, the first three-way valve and the first expansion device are disposed in the same body.

In other words, a single component incorporates the functions of three-way valve and expansion device. The incorporation is facilitated.

The thermal conditioning system may also comprise a second three-way valve disposed jointly on the fourth bypass branch and on the sixth bypass branch, the second three-way valve being configured to selectively:
allow circulation of the refrigerant fluid at the outlet of the fourth expansion device to the eighth connection point and prevent circulation of the refrigerant fluid at the outlet of the fourth expansion device to the twelfth connection point, or
allow circulation of the refrigerant fluid at the outlet of the fourth expansion device to the twelfth connection point and prevent circulation of the refrigerant fluid at the outlet of the fourth expansion device to the eighth connection point.

The second three-way valve and the fourth expansion device may be disposed in the same body.

The disclosure also relates to a method for operating a thermal conditioning system as described above, in a first passenger compartment cooling mode, in which:
a flow of refrigerant fluid at low pressure circulates in the compressor where it is brought to high pressure, and then circulates successively in the first heat exchanger, without exchanging heat with the first heat transfer fluid, in the third bypass branch, in the third heat exchanger, in the second bypass branch, in the first refrigerant fluid accumulation device, in the fifth expansion device where it is brought to low pressure, in the fourth heat exchanger where it evaporates, absorbing heat from the inside air flow, and returns to the compressor.

The disclosure also relates to a method for operating a thermal conditioning system as described above, in a mode referred to as heat pump mode, in which:
a flow of refrigerant fluid at low pressure circulates in the compressor where it is brought to high pressure, and then circulates successively in the first heat exchanger, giving up heat to the first heat transfer fluid, in the first expansion device where it undergoes expansion to an intermediate pressure, in the first refrigerant fluid accumulation device, in the third expansion device where it is brought to low pressure, in the third heat exchanger where it evaporates, absorbing heat from the outside air flow, and returns to the compressor.

The disclosure also relates to a method for operating a thermal conditioning system as described above, in a mode referred to as energy recovery mode, in which:
flow of refrigerant fluid at low pressure circulates in the compressor where it is brought to high pressure, and then circulates successively in the first heat exchanger, giving up heat to the first heat transfer fluid, in the first expansion device where it undergoes expansion to an intermediate pressure, in the first refrigerant fluid accumulation device, in the second expansion device where it is brought to low pressure, in the second heat exchanger where it evaporates, absorbing heat, and returns to the compressor.

The disclosure also relates to a method for operating a thermal conditioning system as described above, in a second passenger compartment cooling mode, in which:
a flow of refrigerant fluid at low pressure circulates in the compressor where it is brought to high pressure, and then circulates successively in the fourth bypass branch, in the fourth expansion device, in the sixth bypass branch, in the third heat exchanger, in the third expansion device, in the second bypass branch, in the first refrigerant fluid accumulation device, in the fifth expansion device where it is brought to low pressure, in the fourth heat exchanger where it evaporates, absorbing heat from the inside air flow, and returns to the compressor.

### BRIEF DESCRIPTION OF THE DRAWINGS

Further features, details and advantages will become apparent on reading the detailed description below, and on studying the attached drawings, in which:

FIG. 1 is a schematic view of a thermal conditioning system according to a first embodiment of the invention,

FIG. 2 is a schematic view of a thermal conditioning system according to a variant of the first embodiment of the invention,

FIG. 3 is a schematic view of a thermal conditioning system according to a second embodiment of the invention,

FIG. 4 is a schematic view of a thermal conditioning system according to a variant of the second embodiment of the invention,

FIG. 5 is a schematic view of a thermal conditioning system according to a third embodiment of the invention,

FIG. 6 is a schematic view of a thermal conditioning system according to a variant of the third embodiment of the invention,

FIG. 7 is a schematic view of the thermal conditioning system in FIG. 3, operating in a first operating mode, referred to as first cooling mode,

FIG. 8 is a schematic view of the thermal conditioning system in FIG. 3, operating in a second operating mode, referred to as heat pump mode,

FIG. 9 is a schematic view of the thermal conditioning system in FIG. 3, operating in a third operating mode, referred to as energy recovery mode,

FIG. 10 is a schematic view of the thermal conditioning system in FIG. 5, operating in a fourth operating mode, referred to as second cooling mode.

### DESCRIPTION OF THE EMBODIMENTS

To make the figures easier to read, the various elements are not necessarily shown to scale. In these figures, identical elements bear the same reference signs. Certain elements or parameters may be indexed, that is to say designated for example as the first element or the second element, or indeed the first parameter and the second parameter, etc. The aim of this indexing is to differentiate between elements or parameters which are similar but not identical. This indexing does not imply the priority of one element or parameter with respect to another, and the denominations may be interchanged.

In the description that follows, the expression “a first element upstream of a second element” means that the first element is placed before the second element with respect to the direction of circulation, or travel, of a fluid. Similarly, the expression “a first element downstream of a second element” means that the first element is placed after the second element with respect to the direction of circulation, or travel, of the fluid in question. In the case of the refrigerant fluid circuit, the expression “a first element is upstream of a second element” means that the refrigerant fluid travels successively through the first element and then the second element, without passing via the compression device. In other words, the refrigerant fluid exits the compression device, possibly passes through one or more elements and then passes through the first element, then the second element, and then returns to the compression device, in some cases having passed through further elements.

The expression “a second element is placed between a first element and a third element” means that the shortest path for traveling from the first element to the third element passes via the second element.

When it is specified that a sub-system has a given element, this does not rule out the presence of other elements in this sub-system.

An electronic control unit 44 receives information from various sensors that notably measure the characteristics of the refrigerant fluid at various points in the circuit. The electronic control unit 44 also receives instructions issued by the occupants of the vehicle, such as for example the desired temperature inside the passenger compartment. The electronic control unit 44 may also receive instructions from other electronic sub-systems, such as the management system for the electrical energy storage batteries. The electronic control unit 44 implements control laws making it possible to control various actuators, in order to control the thermal conditioning system 100 so as to carry out the instructions received.

The refrigerant fluid circuit 10 forms a closed circuit in which the refrigerant fluid can circulate. The refrigerant fluid circuit 10 is fluid-tight when it is in a nominal operating state, i.e. without defects or leaks. Each connection point of the circuit 10 allows the refrigerant fluid to pass into one or the other of the circuit portions that meet at this connection point. The refrigerant fluid is distributed between the circuit portions meeting at a connection point by adjusting the opening or closure of the shut-off valves, non-return valves or expansion devices included on each of the branches. In other words, each connection point is a means for redirecting the refrigerant fluid arriving at this connection point. Various shut-off valves and non-return valves thus make it possible to selectively direct the refrigerant fluid into the various branches of the refrigerant circuit, in order to provide various operating modes, as will be described below.

The refrigerant fluid used by the refrigerant fluid circuit 10 is in this case a chemical fluid such as R1234yf. Other refrigerant fluids may also be used instead, such as R134a or R290.

An inside air flow Fi is understood to mean an air flow intended for the passenger compartment of the motor vehicle. This inside air flow Fi may circulate in a heating, ventilation and/or air conditioning (HVAC) installation. This installation has not been shown in the various figures. A first motor-fan unit (not shown) is disposed in the heating, ventilation and/or air conditioning installation in order to increase, if necessary, the flow rate of the inside air flow Fi.

An outside air flow Fe is understood to mean an air flow that is not intended for the passenger compartment of the vehicle. In other words, this air flow Fe remains outside the passenger compartment of the vehicle. A second motor-fan unit (also not shown) may be activated in order to increase, if necessary, the flow rate of the outside air flow Fe. The flow rate of air provided by the first and the second motor-fan unit may be adjusted in real time depending on the heat exchange requirements, for example by the electronic control unit 44 of the thermal conditioning system 100.

The term “first exchanger” is equivalent to the term “first heat exchanger”. The term “accumulation device” is equivalent to the term “refrigerant fluid accumulation device”.

The heat transfer liquid circuit or circuits also form one or more closed and fluid-tight circuits in which a heat transfer liquid can circulate.

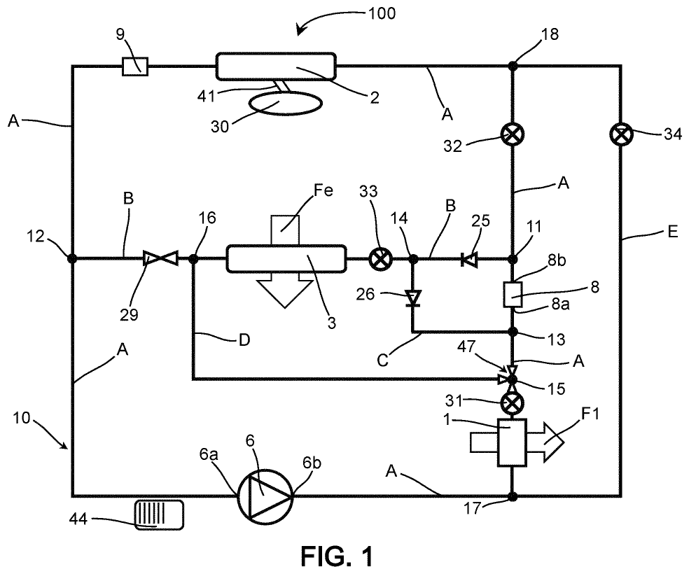

FIG. 1 shows a thermal conditioning system 100 for a motor vehicle, according to a first embodiment.

This thermal conditioning system 100 comprises a refrigerant fluid circuit 10 configured to circulate a refrigerant fluid, the refrigerant fluid circuit 10 comprising:
a main loop A comprising, successively in the direction of circulation of the refrigerant fluid:
   a compressor 6,
   a first heat exchanger 1 configured to exchange heat with a first heat transfer fluid F1,
   a first expansion device 31,
   a first refrigerant fluid accumulation device 8,
   a second expansion device 32,
   a second heat exchanger 2,
a first bypass branch B connecting a first connection point 11 disposed on the main loop A between the first refrigerant fluid accumulation device 8 and the second expansion device 32 to a second connection point 12 disposed on the main loop A between the second heat exchanger 2 and an inlet 6a of the compressor 6, the first bypass branch B comprising a third expansion device 33 and a third heat exchanger 3,
a second bypass branch C connecting a third connection point 13 disposed on the main loop A between the first expansion device 31 and the first refrigerant fluid accumulation device 8 to a fourth connection point 14 disposed on the first bypass branch B between the first connection point 11 and the third expansion device 33,
a third bypass branch D connecting a fifth connection point 15 disposed on the main loop A between the first expansion device 31 and the third connection point 13 to a sixth connection point 16 disposed on the first bypass branch B between the third heat exchanger 3 and the second connection point 12,
a fourth bypass branch E connecting a seventh connection point 17 disposed on the main loop A between an outlet 6b of the compressor 6 and the first heat exchanger 1 to an eighth connection point 18 disposed on the main loop A between the second expansion device 32 and the second connection point 12, the fourth bypass branch E comprising a fourth expansion device 34.

This architecture of the refrigerant fluid circuit makes it possible to obtain numerous operating modes that notably make it possible to heat the first heat transfer fluid F1 at the first exchanger 1 using heat recovered at the second exchanger 2 or at the third exchanger 3. The fourth bypass branch E additionally makes it possible to increase the flow rate of refrigerant fluid compressed by the compressor 6 and circulating in the circuit 10, making it possible to increase the thermal power provided to the refrigerant fluid. The heating capacity of the thermal conditioning system is improved, that is to say increased. With respect to traditional architectures, this architecture makes it possible to dispense with an additional heating device. It also makes it possible to dispense with a subcooling exchanger. The system is thus simplified, without loss of performance.

The first heat exchanger 1 is configured to operate as a condenser.

The first heat transfer fluid F1 is an air flow Fi inside a passenger compartment of the vehicle. The first exchanger 1 thus makes it possible to directly heat the inside air flow Fi, and thus to heat the passenger compartment of the vehicle.

The second heat exchanger 2 is configured to operate as an evaporator.

The second heat exchanger 2 is thermally coupled to an element 30 of an electric powertrain of a motor vehicle. The second heat exchanger 2 thus makes it possible to cool the element 30 of the drivetrain, in order to keep its temperature within an acceptable range.

The element 30 of the electric powertrain of the vehicle may comprise an electrical energy storage battery. The battery may supply the energy necessary to drive the vehicle.

In a variant or in addition, the element 30 of the electric powertrain of the vehicle may comprise an electric drive motor of the vehicle.

In another variant, or in addition, the element 30 of the electric powertrain of the vehicle may comprise an electronic control unit for the electric drive motor of the vehicle.

According to the examples illustrated, the second heat exchanger 2 is thermally coupled to the element 30 by way of a heat transfer liquid circulating in a secondary heat transfer liquid loop 41.

The heat transfer liquid circulating in the secondary heat transfer liquid loop 41 may be a dielectric fluid. The heat transfer liquid circulating in the secondary heat transfer liquid loop 41 may, in a variant, be a mixture of water and glycol.

According to a variant that is not shown, the second heat exchanger 2 is in contact with the element 30 of the powertrain of the vehicle.

The third heat exchanger 3 is configured to exchange heat with an air flow Fe outside the passenger compartment of a motor vehicle. The third heat exchanger 3 is configured to operate selectively as an evaporator or as a condenser. The third heat exchanger 3 is designated by the term evaporator-condenser. The third exchanger 3 is for example disposed in the front end of the vehicle, behind the radiator grille. The third exchanger 3 thus receives an air flow generated by the forward movement of the vehicle. The third heat exchanger 3 may, according to the operating modes of the thermal conditioning system, recover heat from the outside air flow Fe and transfer it to the refrigerant fluid, or dissipate the heat from the refrigerant fluid into the outside air flow.

The first refrigerant fluid accumulation device 8 is a receiver drier. The receiver drier 8 receives at its inlet 8a a two-phase mixture of refrigerant fluid. The refrigerant fluid exiting the outlet 8b of the receiver drier is in the saturated liquid state. The first accumulation device makes it possible to compensate for the variations, depending on the operating conditions, in the quantity of refrigerant fluid circulating in the circuit 10.

According to the examples illustrated, the main loop A comprises a second refrigerant fluid accumulation device 9 disposed between the second heat exchanger 2 and the second connection point 12.

The second refrigerant fluid accumulation device 9 makes it possible to protect the compressor 6 against the presence of refrigerant fluid in liquid form, notably when the ambient temperature is negative. The second refrigerant fluid accumulation device 9 is an accumulator.

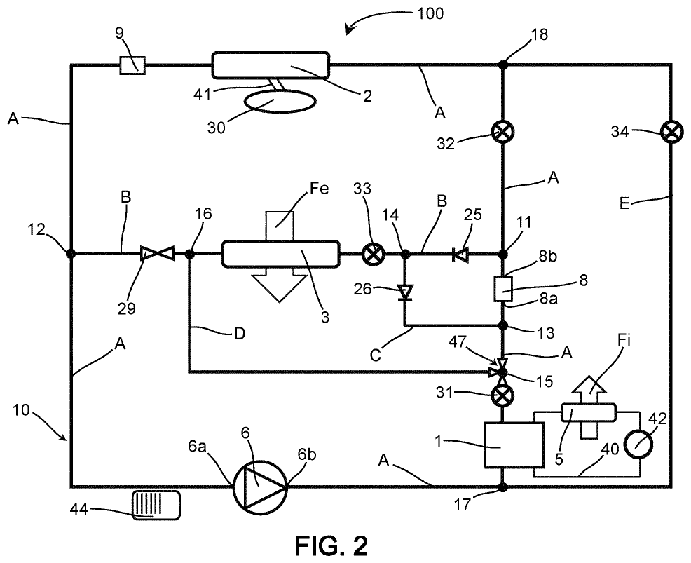

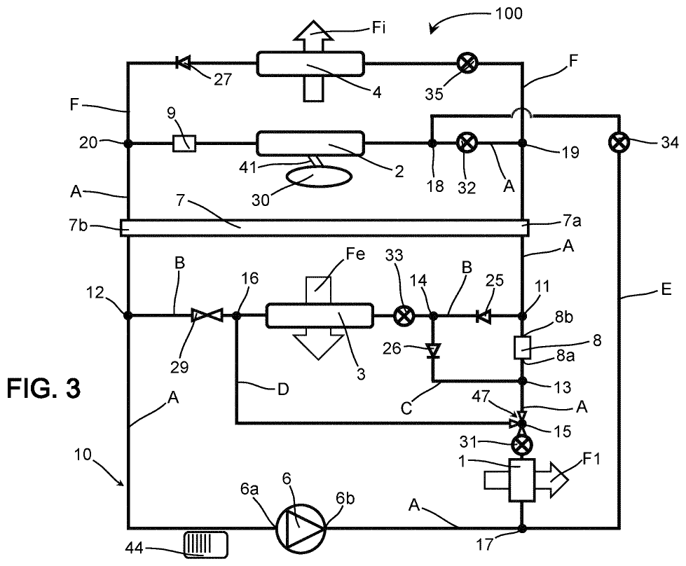

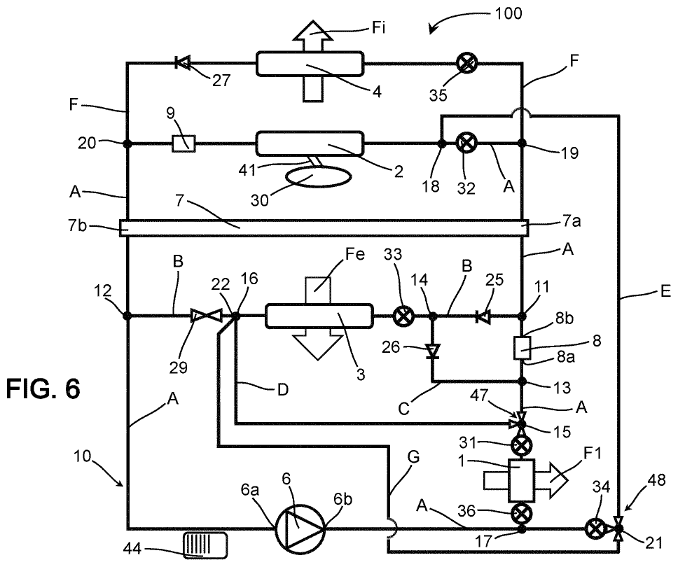

According to the embodiment in FIG. 1, the eighth connection point 18 is disposed on the main loop A between the second expansion device 32 and the second heat exchanger 2. This arrangement is common with the variant of the first embodiment, illustrated in FIG. 2, with the second embodiment, FIG. 3, and with the variant of the third embodiment, FIG. 6.

According to a variant of this first embodiment, which is illustrated in FIG. 2, the first heat transfer fluid F1 is a heat transfer liquid.

In this variant, the thermal conditioning system comprises a heat transfer liquid circuit 40 configured to circulate a heat transfer liquid. The first heat exchanger 1 is a two-fluid heat exchanger arranged jointly on the refrigerant fluid circuit 10 and on the heat transfer fluid circuit 40 so as to allow heat exchange between the refrigerant fluid and the heat transfer liquid.

Still in this variant, the heat transfer fluid circuit 40 comprises a fifth heat exchanger 5 configured to exchange heat with an air flow Fi inside the passenger compartment of the vehicle. The fifth exchanger 5 is disposed in the heating, ventilation and/or air conditioning installation and makes it possible to heat the passenger compartment of the vehicle.

In the second embodiment and the third embodiment, and the variants thereof, which are illustrated in FIGS. 3 to 6, the first heat transfer fluid F1 is an air flow Fi inside the passenger compartment of the vehicle. According to variants that are not shown, the first heat transfer fluid F1 is a heat transfer liquid, as described above for the variant of the first embodiment and shown in FIG. 2.

FIG. 3 shows a second embodiment.

According to this second embodiment, the thermal conditioning system 100 comprises a fifth bypass branch F connecting a ninth connection point 19 disposed on the main loop A between the first connection point 11 and the second expansion device 32 to a tenth connection point 20 disposed on the main loop A between the second accumulation device 9 and the second connection point 12. The fifth bypass branch F comprises a fifth expansion device 35 and a fourth heat exchanger 4.

The fourth heat exchanger 4 is in this case configured to exchange heat with an air flow Fi inside the passenger compartment of the vehicle. The fifth expansion device 35 is disposed upstream of the fourth heat exchanger 4. The fourth heat exchanger 4 is thus configured to operate as an evaporator. The fourth heat exchanger 4 makes it possible to cool the passenger compartment of the vehicle in order to ensure the thermal comfort of the occupants. The fourth heat exchanger is disposed in the heating, ventilation and/or air conditioning installation of the vehicle. According to a variant that is not shown, the fourth heat exchanger 4 is configured to exchange heat with an element of an electric powertrain of the motor vehicle. In other words, the fourth heat exchanger 4 may be thermally coupled to an element of an electric powertrain of the motor vehicle. In this case, the second exchanger 2 and the fourth exchanger 4 have similar roles, making it possible to cool or recover energy from one or more elements of the powertrain.

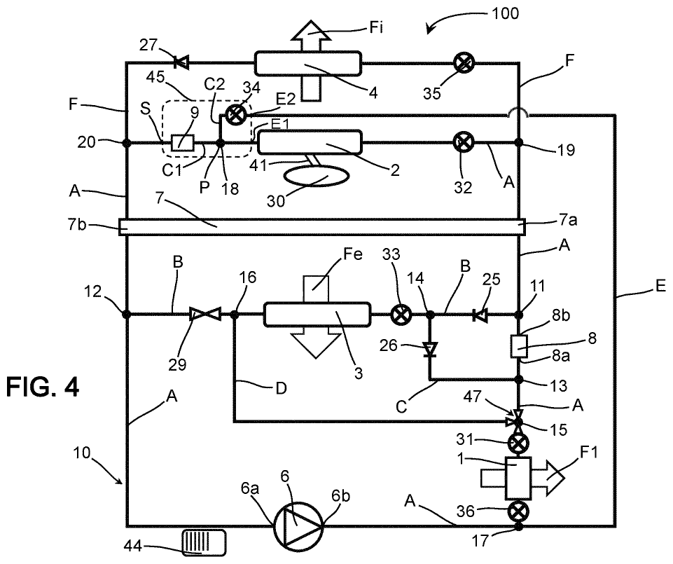

According to a variant of the second embodiment, schematically shown in FIG. 4, the eighth connection point 18 is disposed on the main loop A between the second heat exchanger 2 and the second accumulation device 9.

In other words, the variant in FIG. 4 differs from the embodiment in FIG. 3 notably by the position of the connection point of the downstream part of the fourth bypass branch E with the main branch A.

This variant of the position of the eighth connection point 18 is also applicable to the first embodiment, and has not been shown for this first embodiment.

In this variant of the second embodiment, the thermal conditioning system 100 comprises a refrigerant fluid distribution module 45 comprising:
a first refrigerant fluid inlet E1,
a second refrigerant fluid inlet E2,
a refrigerant fluid outlet S,
a first duct C1 connecting the first inlet E1 to the outlet S,
a second duct C2 connecting the second inlet E2 to a connecting point P disposed on the first duct C1 between the first inlet E1 and the outlet S,
the second accumulation device 9,
the fourth expansion device 34.

The second accumulation device 9 is disposed on the first duct C1 between the connecting point P and the outlet S, and the fourth expansion device 34 is disposed on the second duct C2 between the second inlet E2 and the connecting point P.

The connecting point P corresponds to the eighth connection point 18.

The module 45 thus incorporates the fourth expansion device 34, the second refrigerant fluid accumulation device 9, and two inlets and an outlet for refrigerant fluid. The incorporation of the thermal conditioning system into the vehicle is thus facilitated, since the module makes it possible to reduce the bulk and the number of fluidic connections to be connected. Specifically, the connections necessary for connecting the inlets/outlets of the accumulation device 9 and of the expansion device 34 are internal to the module 45. The module 45 may comprise a machined casting in which the various components are incorporated.

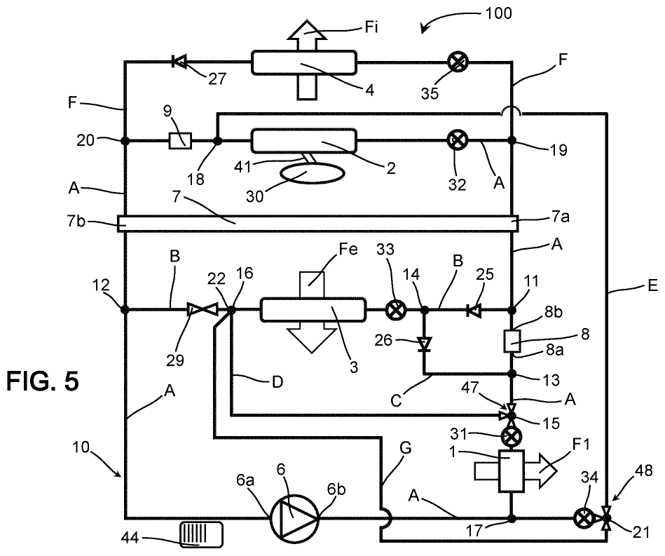

FIG. 5 shows a third embodiment.

According to this third embodiment, the thermal conditioning system 100 comprises a sixth bypass branch G connecting an eleventh connection point 21 disposed on the fourth bypass branch E between the fourth expansion device 34 and the eighth connection point 18 to a twelfth connection point 22 disposed on the first bypass branch B between the sixth connection point 16 and the second connection point 12.

The refrigerant fluid at high pressure at the outlet of the compressor 6 may thus reach the third exchanger 3, then operating as a condenser, without passing via the first exchanger 1. The pressure loss is thus minimized, making it possible to improve the performance of the system.

The twelfth connection point 22 may be combined with the sixth connection point 16.

According to a variant of the third embodiment, illustrated in FIG. 6, the main loop A comprises a sixth expansion device 36 disposed on the main loop A between the seventh connection point 17 and the first heat exchanger 1.

This expansion device 36 makes it possible to expand the high-pressure refrigerant fluid exiting the compressor 6. It is thus possible to operate the compressor at its maximum permissible outlet pressure, and to expand the refrigerant fluid before it is circulated in the first heat exchanger 1. The compression work is thus increased, making it possible to increase the energy transferred to the refrigerant fluid.

The sixth expansion device 36 may be implemented in each embodiment. The sixth expansion device 36 has also been shown for the variant of the second embodiment illustrated in FIG. 4.

The first expansion device 31 is an electronic expansion device. The second expansion device 32 is an electronic expansion device.

Each expansion device 31, 32, 33, 34, 35, 36 may be an electronic expansion device.

In an electronic expansion device, the passage section allowing the refrigerant fluid to pass through can be adjusted continuously between a closure position and a maximum opening position. To this end, a control unit of the thermal conditioning system controls an electric motor that moves a movable shut-off device controlling the passage section available to the refrigerant fluid.

In the examples illustrated, the first bypass branch B comprises a first one-way valve 25 configured to block circulation of refrigerant fluid from the fourth connection point 14 to the first connection point 11.

The first one-way valve 25 is configured to allow circulation of refrigerant fluid from the first connection point 11 to the fourth connection point 14.

The second bypass branch C comprises a second one-way valve 26 configured to block circulation of refrigerant fluid from the third connection point 13 to the fourth connection point 14.

The second one-way valve 26 is configured to allow circulation of refrigerant fluid from the fourth connection point 14 to the third connection point 13.

The first one-way valve 25 is in this case a non-return valve. Likewise, the second one-way valve 26 is in this case a non-return valve. A non-return valve is a passive member that does not require electrical control.

The third bypass branch D does not comprise a shut-off valve or a heat exchanger.

The main loop A comprises a shut-off valve 29 disposed between the sixth connection point 16 and the second connection point 12.

The shut-off valve 29 makes it possible to selectively interrupt the circulation of refrigerant fluid in the first bypass branch B, between the sixth connection point 16 and the second connection point 12. The shut-off valve 29 is controlled electrically, for example by the control unit 44.

The fifth bypass branch F comprises a third one-way valve 27 configured to block circulation of refrigerant fluid from the tenth connection point 20 to the fourth heat exchanger 4.

The third one-way valve 27 is configured to allow circulation of refrigerant fluid from the fourth heat exchanger 4 to the tenth connection point 20. The third one-way valve 27 is in this case a non-return valve.

According to variants that are not shown, each non-return valve 25, 26, 27 may be replaced by an electrically controlled shut-off valve.

The main loop A of the thermal conditioning system 100 may comprise an internal heat exchanger 7 configured to allow heat exchange between the refrigerant fluid downstream of the first connection point 11 and upstream of the second expansion device 32 and the refrigerant fluid downstream of the second accumulation device 9 and upstream of the second connection point 12.

This feature, present in the second and third embodiment, FIGS. 3 to 6, can also be applied to the first embodiment and the variants thereof.

The internal heat exchanger 7 makes it possible to increase the heat exchange capacity of the thermal conditioning system 100, and also contributes to superheating of the refrigerant fluid at the inlet of the compressor 1, i.e. contributes to avoiding the presence of droplets of liquid refrigerant at the inlet of the compressor 1.

The internal heat exchanger 7 comprises a first heat exchange section 7a disposed on the main loop A downstream of the first connection point 11 and upstream of the second expansion device 32, and a second heat exchange section 7b disposed on the main loop A downstream of the second accumulation device 9 and upstream of the second connection point 12. The first internal heat exchanger 7 is configured to allow heat exchange between the refrigerant fluid in the first heat exchange section 7a and the refrigerant fluid in the second heat exchange section 7b. The refrigerant fluid circulating at high pressure in the main loop A may thus give up heat to the refrigerant fluid circulating at a lower pressure in the main loop A, after expansion in the second expansion device 32. When the thermal conditioning system 100 comprises the fifth bypass branch F, the first heat exchange section 7a is disposed downstream of the first connection point 11 and upstream of the ninth connection point 19. The second heat exchange section 7b is disposed between the tenth connection point 20 and the second connection point 12.

In the examples illustrated, the thermal conditioning system 100 comprises a first three-way valve 47 disposed jointly on the main loop A and on the third bypass branch D.

The first three-way valve 47 is configured to selectively:
allow circulation of the refrigerant fluid at the outlet of the first exchanger 1 to the third connection point 13 and prevent circulation of the refrigerant fluid at the outlet of the first exchanger 1 to the sixth connection point 16, or
allow circulation of the refrigerant fluid at the outlet of the first exchanger 1 to the sixth connection point 16 and prevent circulation of the refrigerant fluid at the outlet of the first exchanger 1 to the third connection point 13.

According to one exemplary embodiment, the first three-way valve 47 and the first expansion device 31 are disposed in the same body. The body can for example be a cast body. The body receiving the first three-way valve 47 and the first expansion device 31 may be in one piece.

In other words, a single component incorporates the functions of three-way valve and expansion device. The incorporation of the component into the thermal conditioning system is facilitated.

According to the third embodiment and the variant thereof, which are illustrated in FIGS. 5 and 6, the thermal conditioning system 100 also comprises a second three-way valve 48 disposed jointly on the fourth bypass branch E and on the sixth bypass branch G.

The second three-way valve 48 is configured to selectively:
allow circulation of the refrigerant fluid at the outlet of the fourth expansion device 34 to the eighth connection point 18 and prevent circulation of the refrigerant fluid at the outlet of the fourth expansion device 34 to the twelfth connection point 22, or
allow circulation of the refrigerant fluid at the outlet of the fourth expansion device 34 to the twelfth connection point 22 and prevent circulation of the refrigerant fluid at the outlet of the fourth expansion device 34 to the eighth connection point 18.

The second three-way valve 48 and the fourth expansion device 34 may be disposed in the same body. The body can for example be a cast body. The body receiving the second three-way valve 48 and the fourth expansion device 34 may be in one piece. This body is separate from the body receiving the first three-way valve 47 and the first expansion device 31.

Each three-way valve 47, 48 may also be replaced by two two-way valves.

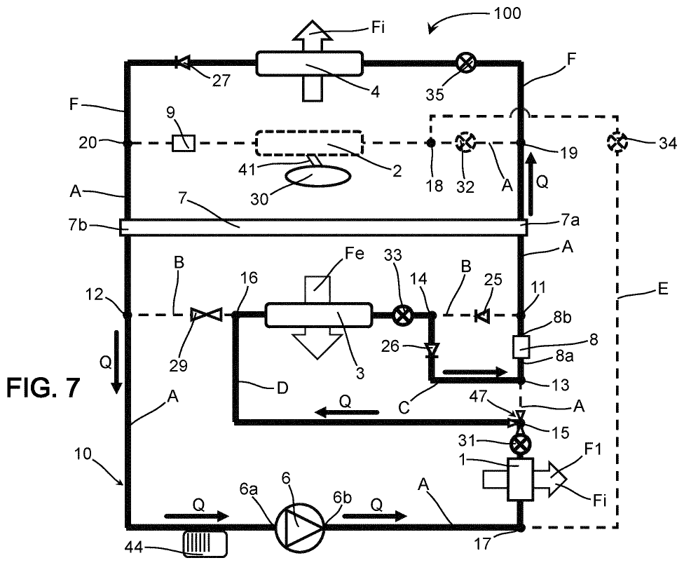

FIG. 7 illustrates a method for operating a thermal conditioning system 100 as described above, in a first passenger compartment cooling mode.

In this mode, referred to as passenger compartment cooling mode:
a flow Q of refrigerant fluid at low pressure circulates in the compressor 6 where it is brought to high pressure, and then circulates successively in the first heat exchanger 1, without exchanging heat with the first heat transfer fluid F1, in the third bypass branch D, in the third heat exchanger 3, in the second bypass branch C, in the first refrigerant fluid accumulation device 8, in the fifth expansion device 35 where it is brought to low pressure, in the fourth heat exchanger 4 where it evaporates, absorbing heat from the inside air flow Fi, and returns to the compressor 1.

In this operating mode, the first expansion device 31 is wide open so as to not expand the high-pressure refrigerant fluid. A flap (not shown) isolates the first exchanger 1 from the inside air flow Fi which is in this case the first heat transfer fluid F1. Heat exchange between the refrigerant fluid and the inside air flow Fi is thus avoided.

The first three-way valve 47 directs the high-pressure refrigerant fluid to the third bypass branch D. The shut-off valve 29 is closed, such that the refrigerant fluid circulates from the sixth connection point 16 to the fourth connection point 14 and condenses in the third exchanger 3. Partial expansion in the third expansion device 33 is possible.

The refrigerant fluid then circulates in the second bypass branch C. Specifically, the first non-return valve 25 blocks the circulation from the fourth connection point 14 to the first connection point 11. The second non-return valve 26 allows circulation of refrigerant fluid from the fourth connection point 14 to the third connection point 13. The refrigerant fluid then passes through the first accumulator 8, and then reaches the ninth connection point 19. The second expansion device 32 is in a closed position, such that no refrigerant fluid circulates in the second exchanger 2. The refrigerant fluid is expanded by passing through the fifth expansion device 35, and is brought to low pressure. The low-pressure refrigerant fluid evaporates in the fourth exchanger 4 and cools the inside air flow Fi. The refrigerant fluid reaches the compressor 6, by passing successively through the tenth connection point 10 and the second connection point 12.

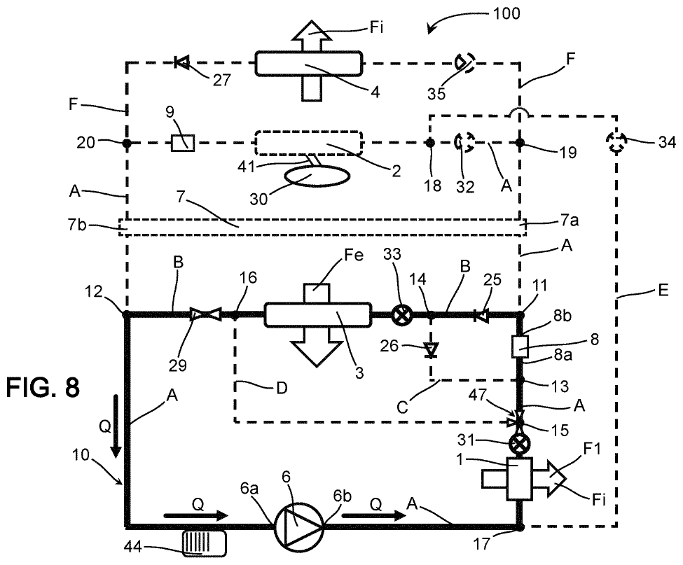

FIG. 8 illustrates a method for operating a thermal conditioning system 100 as described above, in a mode referred to as heat pump mode.

In this mode, referred to as heat pump mode:
a flow Q of refrigerant fluid at low pressure circulates in the compressor 6 where it is brought to high pressure, and then circulates successively in the first heat exchanger 1, giving up heat to the first heat transfer fluid F1, in the first expansion device 31 where it undergoes expansion to an intermediate pressure, in the first refrigerant fluid accumulation device 8, in the third expansion device 33 where it is brought to low pressure, in the third heat exchanger 3 where it evaporates, absorbing heat from the outside air flow Fe, and returns to the compressor 6.

In this operating mode, the refrigerant fluid at high pressure at the outlet of the compressor 6 condenses in the first exchanger 1, making it possible to heat the inside air flow Fi, which is in this case the first heat transfer fluid F1. The refrigerant fluid then undergoes partial expansion in the first expansion device 31 and is brought to intermediate pressure. The intermediate pressure is a pressure lower than the high pressure, and greater than the low pressure. The partial expansion reduces the enthalpy of the refrigerant fluid at the outlet of the first accumulation device 8, and thus increases the recoverable energy at the third exchanger 3. The first three-way valve 47 blocks the circulation of refrigerant fluid in the third bypass branch C and directs the refrigerant fluid from the fifth connection point 15 to the third connection point 13. The refrigerant fluid then passes through the first accumulation device 8. The second expansion device 32 and the fifth expansion device 35 are in a closed position, such that no refrigerant fluid circulates from the first connection point 11 to the ninth connection point 19. The first non-return valve 25 allows circulation of refrigerant fluid in the first bypass branch B, from the first connection point 11 to the second connection point 12. The third expansion device 33 expands the refrigerant fluid until it is in a low-pressure state. The low-pressure refrigerant fluid evaporates in the third exchanger 3, absorbing heat from the outside air flow Fe. The shut-off valve 29 is open, and the evaporated refrigerant fluid returns to the inlet 6a of the compressor 6. It should be noted that the direction of travel of the refrigerant fluid in the third exchanger 3 is reversed compared with the preceding operating mode.

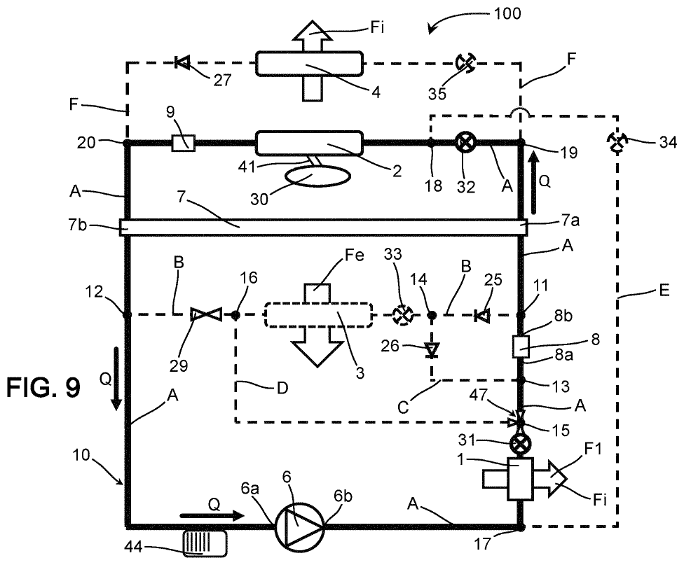

FIG. 9 illustrates a method for operating a thermal conditioning system 100 as described above, in a mode referred to as energy recovery mode.

According to this mode, referred to as energy recovery mode:
a flow Q of refrigerant fluid at low pressure circulates in the compressor 6 where it is brought to high pressure, and then circulates successively in the first heat exchanger 1, giving up heat to the first heat transfer fluid F1, in the first expansion device 31 where it undergoes expansion to an intermediate pressure, in the first refrigerant fluid accumulation device 8, in the second expansion device 32 where it is brought to low pressure, in the second heat exchanger 2 where it evaporates, absorbing heat, and returns to the compressor 6.

The circulation of refrigerant fluid between the outlet 6b of the compressor 6 and the first connection point 11 is identical to the preceding operating mode. In the operating mode in FIG. 9, the third expansion device 33 is in a closed position, and the second expansion device 32 is in a partially open position. There is therefore no circulation of refrigerant fluid in the third exchanger 3, whereas the refrigerant fluid circulates in the second exchanger 2. The refrigerant fluid expanded by the second expansion device 32 evaporates in the second exchanger 2, absorbing heat from the element 30 of the powertrain. This operating mode makes it possible to recover energy from the powertrain of the vehicle at the second exchanger 2 and to transfer it to the inside air flow Fi at the first exchanger 1. The evaporated refrigerant fluid passes through the second accumulation device 9 and reaches the compressor 6. When the ambient temperature is negative, the second accumulation device 9 prevents droplets of liquid refrigerant from reaching the inlet 6a of the compressor 6.

These three operating modes have been shown for a thermal conditioning system according to the second embodiment. They are also applicable to other embodiments of the thermal conditioning system, and to the variant thereof.

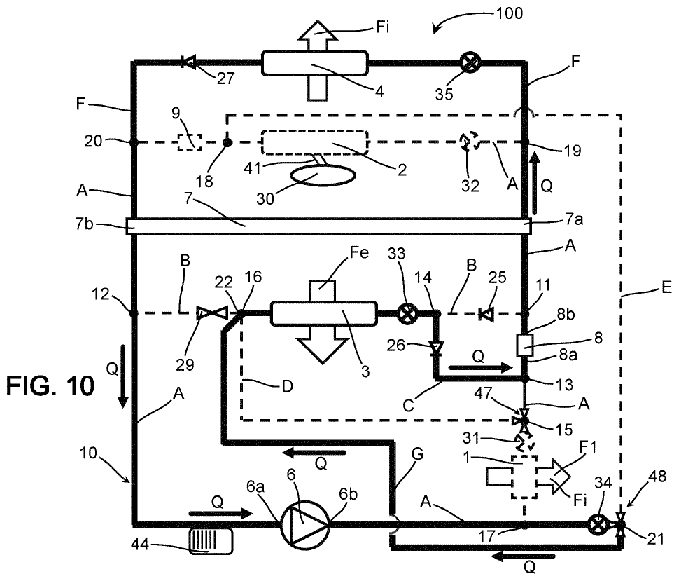

FIG. 10 illustrates a method for operating a thermal conditioning system 100 as described above, in a second passenger compartment cooling mode.

According to this operating mode:
a flow Q of refrigerant fluid at low pressure circulates in the compressor 1 where it is brought to high pressure, and then circulates successively in the fourth bypass branch E, in the fourth expansion device 34, in the sixth bypass branch G, in the third heat exchanger 3, in the third expansion device 33, in the second bypass branch C, in the first refrigerant fluid accumulation device 8, in the fifth expansion device 35 where it is brought to low pressure, in the fourth heat exchanger 4 where it evaporates, absorbing heat from the inside air flow Fi, and returns to the compressor 1.

This operating mode relates to a thermal conditioning system according to the third embodiment, and the variant thereof, which are illustrated respectively in FIGS. 5 and 6.

In this operating mode, the first expansion device 31 is in a closed position, preventing refrigerant fluid from circulating in the first exchanger 1. The fourth expansion device 34 is in an open position. The second three-way valve 48 blocks the circulation in the fourth bypass branch E between the eleventh connection point 21 and the eighth connection point 18, and directs the high-pressure refrigerant fluid into the sixth bypass branch G. The shut-off valve 29 is in a closed position, such that the refrigerant fluid circulates in the third exchanger 3. The circulation of the refrigerant fluid between the sixth connection point 16 and the inlet 6a of the compressor 6 is identical to that described in the first passenger compartment cooling mode, shown in FIG. 7.

Numerous other operating modes are also possible, and have not been shown.

1. A thermal conditioning system for a motor vehicle, comprising a refrigerant fluid circuit configured to circulate a refrigerant fluid, the refrigerant fluid circuit comprising:
a main loop comprising, successively in a direction of circulation of the refrigerant fluid:
a compressor,
a first heat exchanger configured to exchange heat with a first heat transfer fluid,
a first expansion device,
a first refrigerant fluid accumulation device,
a second expansion device, and
a second heat exchanger;
a first bypass branch connecting a first connection point disposed on the main loop between the first refrigerant fluid accumulation device and the second expansion device to a second connection point disposed on the main loop between the second heat exchanger and an inlet of the compressor,
wherein the first bypass branch comprising a third expansion device and a third heat exchanger;
a second bypass branch connecting a third connection point disposed on the main loop between the first expansion device and the first refrigerant fluid accumulation device to a fourth connection point disposed on the first bypass branch between the first connection point and the third expansion device;
a third bypass branch connecting a fifth connection point disposed on the main loop between the first expansion device and the third connection point to a sixth connection point disposed on the first bypass branch between the third heat exchanger and the second connection point; and
a fourth bypass branch connecting a seventh connection point disposed on the main loop between an outlet of the compressor and the first heat exchanger to an eighth connection point disposed on the main loop between the second expansion device and the second connection point,
wherein the fourth bypass branch comprising a fourth expansion device.

2. The thermal conditioning system as claimed in claim 1, wherein the main loop comprises a second refrigerant fluid accumulation device disposed between the second heat exchanger and the second connection point.

3. The thermal conditioning system as claimed in claim 1, wherein the eighth connection point is disposed on the main loop between the second expansion device and the second heat exchanger.

4. The thermal conditioning system as claimed in claim 2, wherein the eighth connection point is disposed on the main loop between the second heat exchanger and the second accumulation device.

5. The thermal conditioning system as claimed in claim 2, comprising a refrigerant fluid distribution module comprising:
a first refrigerant fluid inlet;
a second refrigerant fluid inlet;
a refrigerant fluid outlet;
a first duct connecting the first inlet to the outlet;
a second duct connecting the second inlet to a connecting point disposed on the first duct between the first inlet and the outlet;
the second accumulation device; and
the fourth expansion device,
wherein the second accumulation device is disposed on the first duct between the connecting point and the outlet, and
wherein the fourth expansion device is disposed on the second duct between the second inlet and the connecting point.

6. The thermal conditioning system as claimed in claim 1, wherein the first heat transfer fluid is an air flow inside a passenger compartment of the vehicle.

7. The thermal conditioning system as claimed in claim 2, comprising a fifth bypass branch connecting a ninth connection point disposed on the main loop between the first connection point and the second expansion device to a tenth connection point disposed on the main loop between the second accumulation device and the second connection point,
wherein the fifth bypass branch comprising a fifth expansion device and a fourth heat exchanger,
wherein the fourth heat exchanger is configured to exchange heat with an air flow inside a passenger compartment of the vehicle or with an element of an electric powertrain of the motor vehicle.

8. The thermal conditioning system as claimed in claim 1,
wherein the first heat transfer fluid is a heat transfer liquid,
wherein the thermal conditioning system comprises a heat transfer liquid circuit configured to circulate a the heat transfer liquid,
wherein the first heat exchanger is a two-fluid heat exchanger arranged jointly on the refrigerant fluid circuit and on the heat transfer fluid circuit so as to allow heat exchange between the refrigerant fluid and the heat transfer liquid, and
wherein the heat transfer fluid circuit comprises a fifth heat exchanger configured to exchange heat with an air flow inside a passenger compartment of the vehicle.

9. The thermal conditioning system as claimed in claim 1, wherein the second heat exchanger is thermally coupled to an element of an electric powertrain of the motor vehicle,
wherein the element of the electric powertrain of the vehicle comprising an electrical energy storage battery,
or an electric drive motor of the vehicle,
or an electronic control unit for the electric drive motor of the vehicle.

10. The thermal conditioning system as claimed in claim 1,
wherein the first bypass branch comprises a first one-way valve configured to block circulation of the refrigerant fluid from the fourth connection point to the first connection point, and
wherein the second bypass branch comprises a second one-way valve configured to block circulation of the refrigerant fluid from the third connection point to the fourth connection point.

11. The thermal conditioning system as claimed in claim 1, further comprising a sixth bypass branch connecting an eleventh connection point disposed on the fourth bypass branch between the fourth expansion device and the eighth connection point to a twelfth connection point disposed on the first bypass branch between the sixth connection point and the second connection point.

12. The thermal conditioning system as claimed in claim 2, wherein the main loop comprises an internal heat exchanger configured to allow heat exchange between the refrigerant fluid downstream of the first connection point and upstream of the second expansion device and the refrigerant fluid downstream of the second accumulation device and upstream of the second connection point.

13. The thermal conditioning system as claimed in claim 1, wherein the main loop comprises a sixth expansion device disposed on the main loop between the seventh connection point and the first heat exchanger.

14. The thermal conditioning system as claimed in claim 1, comprising a first three-way valve disposed jointly on the main loop and on the third bypass branch, wherein the first three-way valve is configured to selectively:
allow circulation of the refrigerant fluid at the outlet of the first exchanger to the third connection point and prevent circulation of the refrigerant fluid at the outlet of the first exchanger to the sixth connection point, or
allow circulation of the refrigerant fluid at the outlet of the first exchanger to the sixth connection point and prevent circulation of the refrigerant fluid at the outlet of the first exchanger to the third connection point,
wherein the first three-way valve and the first expansion device are disposed in the same body.

15. The thermal conditioning system as claimed in claim 11, further comprising a second three-way valve disposed jointly on the fourth bypass branch and on the sixth bypass branch, wherein the second three-way valve is configured to selectively:
allow circulation of the refrigerant fluid at the outlet of the fourth expansion device to the eighth connection point and prevent circulation of the refrigerant fluid at the outlet of the fourth expansion device (34) to the twelfth connection point, or
allow circulation of the refrigerant fluid at the outlet of the fourth expansion device to the twelfth connection point and prevent circulation of the refrigerant fluid at the outlet of the fourth expansion device to the eighth connection point, and
wherein the second three-way valve and the fourth expansion device are disposed in the same body.
